(19) United States
(12) Patent Application Publication
(10) Pub. No.: US 2018/0115684 A1
(43) Pub. Date: Apr. 26, 2018

(54) IMAGE PROCESSING SYSTEM AND IMAGE PROCESSOR

(71) Applicant: ASUSTeK COMPUTER INC., TAIPEI (TW)

(72) Inventors: Shu-Hui CHOU, TAIPEI (TW); Shih-Hao KE, TAIPEI (TW); Min-Che HUANG, TAIPEI (TW)

(21) Appl. No.: 15/486,317

(22) Filed: Apr. 13, 2017

(30) Foreign Application Priority Data
Oct. 20, 2016 (TW) 105133921

(51) Int. Cl. H04N 5/14; H04N 5/232

(52) U.S. Cl. CPC H04N 5/147; H04N 5/23293; H04N 5/144

(57) ABSTRACT

An image processing system is provided. The image processing system includes a sensing unit configured for detecting environmental change and generating environmental information; an analyzing unit electrically connected to the sensing unit and configured for analyzing whether to generate a enable signal according to the environmental information; an image capturing unit electrically connected to the analyzing unit and configured for capturing an environment image according to the enable signal; a processing unit electrically connected to the image capturing unit and configured for performing an image processing to the environment image to generate an object image; and a display unit electrically connected to the processing unit and configured for displaying the object image. An image processor adapted to the image processing system is also provided.

### CROSS-REFERENCE TO RELATED APPLICATION

This application claims the priority benefit of TW application serial No. 105133921, filed on Oct. 20, 2016. The entirety of the above-mentioned patent application is hereby incorporated by references herein and made a part of specification.

### BACKGROUND OF THE INVENTION

### Field of the Invention

The disclosure relates to an image processing system and an image processor.

### Description of the Related Art

With the rapid development of the control technology, automation devices are important in human life. For example, robots are widely used in the health care or product manufacturing field. Generally, the robot interacts with a user according to a preset operating mode. However, the user could not intuitively determine whether the interaction relationship with the robot is established though a display image of the robot.

### BRIEF SUMMARY OF THE INVENTION

According to an aspect of the disclosure, an image processing system is provided. The image processing system comprising: a sensing unit configured for detecting environmental change and generating environmental information; an analyzing unit electrically connected to the sensing unit and configured for analyzing whether to generate an enable signal according to the environmental information; an image capturing unit electrically connected to the analyzing unit and configured for capturing an environment image according to the enable signal; a processing unit electrically connected to the image capturing unit and configured for performing an image processing to the environment image to generate an object image; and a display unit electrically connected to the processing unit and configured for displaying the object image.

According to another aspect of the disclosure, an image processor adapted to an image processing system is provided. The image processing system includes a sensing unit, an analyzing unit, an image capturing unit, a processing unit and a display unit. The image processor comprising: detecting environmental changes and generating environmental information via the sensing unit; analyzing whether to generate an enable signal according to the environmental information via the analyzing unit; capturing an environment image according to the enable signal via the image capturing unit; performing an image processing to the environment image via the processing unit to generate an object image; and displaying the object image via the display unit.

In sum, in the image processing system and the image processor in embodiments, the image capturing unit determines whether the ambient environment changes according to the environmental information generated by the sensing unit to selectively capture the environment image. Then, the processing unit performs the image processing on the environment image to generate the object image. The object image is displayed on the display unit instantly. In an embodiment, the object image is an image of the user. The image processing system and the image processor of the disclosure provides a mirror reflection effect by displaying the object image on the display unit instantly. Therefore, the establishment of the interaction relationship between the automation device and the user can be determined at once, which makes the automation device more user-friendly.

### BRIEF DESCRIPTION OF THE DRAWINGS

These and other features, aspects and advantages of the disclosure will become better understood with regard to the following embodiments and accompanying drawings.

FIG. 1 is a block diagram showing an image processing system in an embodiment;

FIGS. 2A and 2B are schematic diagrams showing an image processing system when ambient environment changes in an embodiment, respectively;

FIG. 2C is a schematic diagram showing an image processing system in an operating state in an embodiment;

FIGS. 2D and 2E are schematic diagrams showing an image processing system when ambient environment changes in an environment, respectively;

FIG. 2F is a schematic diagram showing an image processing system in an operating state in an embodiment; and

FIG. 3 is a flow chart of an image processor in an embodiment.

### DETAILED DESCRIPTION OF THE EMBODIMENTS

To better understand the disclosure, details of embodiments are described hereinafter accompanying with the figures, which are not used for limiting the scope of the present disclosure. Operations described in embodiments of the present disclosure do not limit to the sequence of steps in embodiments. The configuration of the structure in embodiments can be varied to perform the same functionality. Generally, the drawings are shown only for illustration, in which the components are not represented in their actual size. For better understanding, the sizes of various components can be enlarged or reduced. Same or similar reference symbol denotes same or similar components described hereinafter.

Unless mentioned otherwise, the terms used throughout the specification and the claims usually refer to their general meanings in the art, in the disclosure except explained specially. Some terms for describing the disclosure are discussed hereinafter or elsewhere in the specification to provide other understanding/interpretation to the disclosure for the person having ordinary skills in the art.

Additionally, the terms, such as “comprise”, “include”, “contain” and “have/has”, are open-ended terms, which means “include but not limited to”. Moreover, the word “and/or” includes any one of one or more listed item(s) and all combinations thereof.

In the present disclosure, when it is described that a component is connected/coupled, the “connect/couple” refers to “electrically connected/coupled (to)” or the cooperation/interacting relationship between two or more than two components.

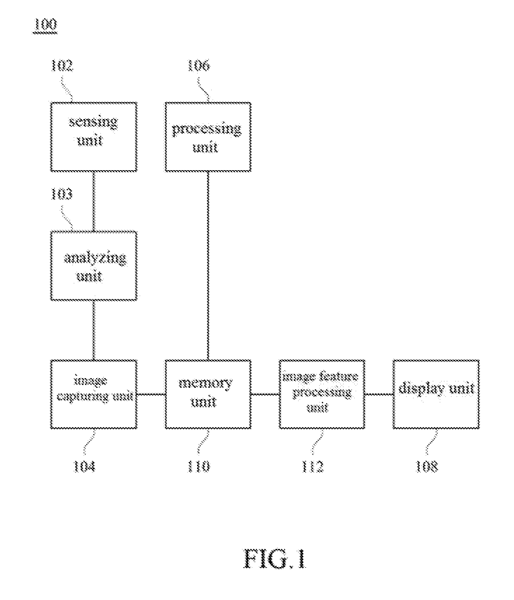

FIG. 1 is a block diagram showing an image processing system in an embodiment. As shown in FIG. 1, an image processing system 100 includes a sensing unit 102, an analyzing unit 103, an image capturing unit 104, a processing unit 106 and a display unit 108. The analyzing unit 103 is electronically connected to the sensing unit 102. The image capturing unit 104 is electrically connected to the analyzing unit 103. The processing unit 106 is electrically connected to the image capturing unit 104. The display unit 108 is electrically connected to the processing unit 106.

The sensing unit 102 detects environmental changes to generate environmental information, and sends the environmental information to the image capturing unit 104.

The analyzing unit 103 analyzes whether the environment surrounding the image processing system 100 changes according to the environmental information. The environmental changes includes a situation in which an object in the environment changes, and a situation in which the position or the orientation of the image processing system 100 changes under the control or an external force. If the analyzing unit 103 determines the environment surrounding the image processing system 100 changes according to the environmental information, the analyzing unit 103 generates and sends an enable signal to the image capturing unit 104.

The image capturing unit 104 receives the enable signal to capture an environment image according to the enable signal, and sends the environment image to the processing unit 106. The processing unit 106 receives the environment image and performs an image processing on the environment image and generates an object image. Then, the processing unit 106 sends the object image to the display unit 108. The display unit 108 receives and displays the object image.

In an embodiment, the image processing system 100 further includes a memory unit 110. The memory unit 110 is electrically connected to the image capturing unit 104 and the processing unit 106. The environment image is stored in the memory unit 110. In an embodiment, when the analyzing unit 103 determines the environment surrounding the processing system 100 changes according to the environmental information, the analyzing unit 103 generates and sends the enable signal to the image capturing unit 104. The image capturing unit 104 captures the environment image according to the enable signal and stores the environment image into the memory unit 110.

In an embodiment, the processing unit 106 obtains the environment image from the memory unit 110 and performs the image processing on the environment image to generate the object image. Then, the processing unit 106 stores the object image into the memory unit 110. The object image is sent from the memory unit 110 to the display unit 108.

In an embodiment, the image processing system 100 further includes an image feature processing unit 112. The image processing unit 112 is electrically connected to the memory unit 110 and the display unit 108. The image feature processing unit 112 performs an image feature processing on the object image according to the display unit 108, and sends the processed object image to the display unit 108. Thus, the display unit 108 can instantly displays the processed object image.

In an embodiment, the image feature processing unit 112 adjusts the image feature (such as the shape and the size) of the object image according to the shape and the size of the display unit 108. When the shape of the display unit 108 is round, the image feature processing unit 112 adjusts the shape of the object image to be round and adjusts the radius to match the object image with the display unit 108 exactly. In such a way, the whole display area of the display unit 108 is effectively used for displaying the object image with no blank display area (which is not used for displaying the object image in the display unit 108) left. The display unit 108 is effectively used to display the object image. It is understood that the embodiments are described for exemplifying the image feature processing unit 112 and the display unit 108, but not for limiting the present disclosure. In the embodiments, the shape of the display unit 108 is various for normal display, such as a round shape, an oval shape and a square shape.

In an embodiment, when the analyzing unit 103 determines a moving object appears in the environment surrounding the image processing system 100 according to the environmental information, the analyzing unit 103 generates and sends an enable signal to the image capturing unit 104. The image capturing unit 104 captures the environment image of the moving object according to the enable signal.

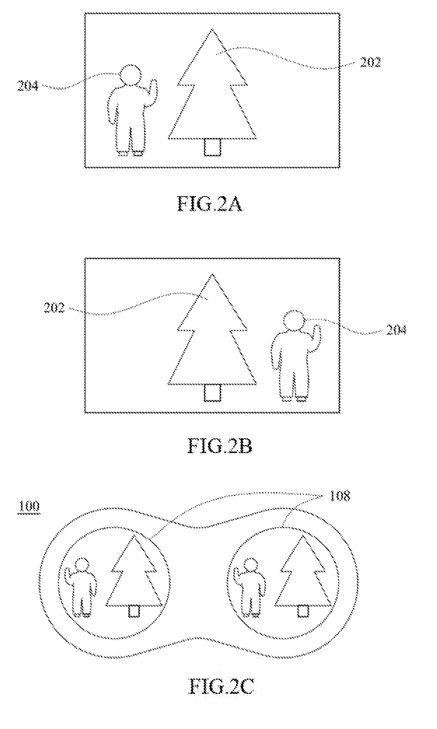

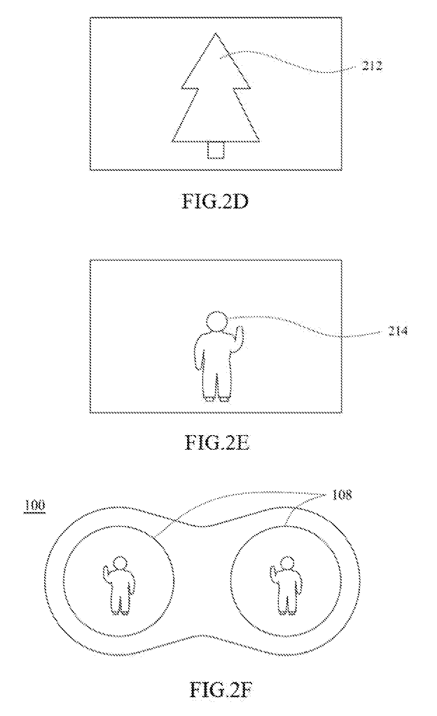

FIGS. 2A and 2B are schematic diagrams showing an image processing system when the ambient environment changes in an embodiment, respectively. FIG. 2C is a schematic diagram showing an image processing system in an operating state in an embodiment. As shown in FIGS. 2A and 2B, an object 202 is a fixed object and an object 204 is a moving object. FIGS. 2A and 2B show that the object 204 moves from the left side of the object 202 to the right side of the object 202. When the object 204 moves from the left side of the object 202 to the right side of the object 202, the sensing unit 102 detects the movement of the object 204 and generates environmental information.

In an embodiment, the sensing unit 102 is an infrared detector, an image sensor or any other sensors used for detecting a moving object. After the analyzing unit 103 determines that the moving object 284 appears in the environment surrounding the image processing system 100 according to the environmental information, the analyzing unit 103 generates and sends the enable signal to the image capturing unit 104 to request the image capturing unit 104 to capture the environment image of the object 204 instantly. Then, as show in FIG. 2C, the image processing system 100 generates the image of the object 204 via the processing unit 106. The image of the object 204 is displayed instantly on the display unit 108.

In an embodiment, please refer to FIGS. 2B and 2C, a real image (as shown in FIG. 2B) of the moving object 204 is a mirror reflection of the object image (as shown in FIG. 2C) of the moving object 204 displayed on the display unit 108.

In an embodiment, the image processing system 100 is applied in an automation device (such as, a home robot, a health-care robot, a security robot and the like) as an interaction interface for interacting with a user, which is not limited herein.

In an embodiment, when the user gets close to the automation device with the image processing system 100, the image processing system 100 detects the approach of the user and captures an image of the user immediately. The image processing system 100 processes the image of the user to generate an image of the user, and displays the image of the user instantly to provide a mirror reflection effect to the user. In such a way, the user can have the interaction relationship with the automation device quickly, which is user-friendly.

In an embodiment, when the analyzing unit 103 determines the image processing system 100 is moved according to the environmental information, the analyzing unit 103 generates and sends the enable signal to the image capturing unit 104. The image capturing unit 104 captures the environment image around the image processing system 100 according to the enable signal.

In an embodiment, when the position or the orientation of the image processing system 100 changes under the control or the external force, the sensing unit 102 detects the movement of the image processing system 100 and generates the environmental information. In an embodiment, the sensing unit 102 can be any sensor used for detecting the movement, such as, an accelerometer, a gyroscope and a magnetic sensor.

When the analyzing unit 103 determines the image processing system 100 is moved according to the environmental information, the analyzing unit 103 generates and sends the enable signal to the image capturing unit 104 to request the image capturing unit 104 to capture the environment image around the image processing system 100 instantly. Then, the image processing system 100 generates the image of the object 204 via the processing unit 106. The image of the object 204 is displayed instantly on the display unit 108.

In an embodiment, the sensing unit 102 can be any sensor used for detecting a moving object, such as a photo-sensor, a sound sensor and an image sensor.

FIGS. 2D and 2E are schematic diagrams showing an image processing system 100 when ambient environment changes in an embodiment. FIG. 2F is a diagram showing an image processing system 100 in an embodiment. As shown in FIGS. 2D and 2E, when the position or the orientation of the image processing system 100 changes under the control or the external force, the sensing unit 102 detects the object surrounding the image processing system 100 is changed from the object 212 to the object 214. Then, the sensing unit 102 generates the environmental information.

When the analyzing unit 103 determines the image processing system 100 is moved according to the environmental information, the analyzing unit 103 generates and sends the enable signal to the image capturing unit 104 to request the image capturing unit 104 to capture the environment image of the object 214. Then, as shown in FIG. 2F, the image processing system 100 generates the image of the object 214 via the processing unit 106. The image of the object 214 is displayed on the display unit 108. In an embodiment, please refer to FIGS. 2E and 2F, the real image of the object 214 (as shown in FIG. 2E) is a mirror reflection of the displayed object image (as shown in FIG. 2F) of the object 214 on the display unit 108.

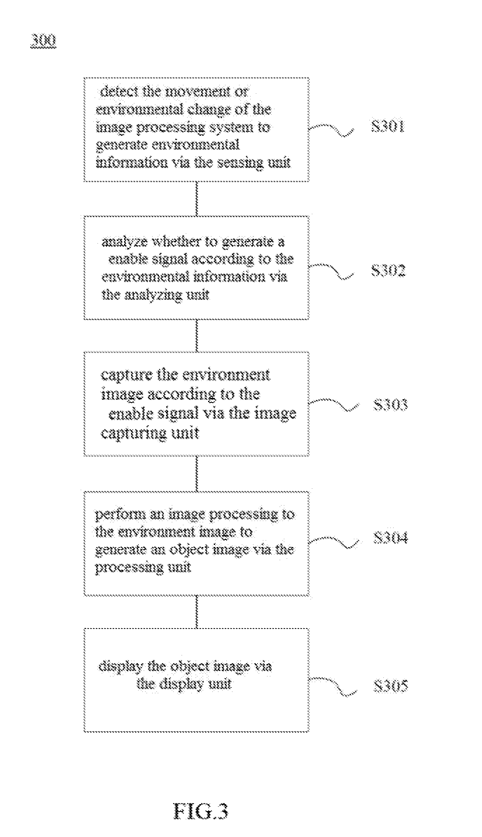

FIG. 3 is a flow chart of an image processor 300 in an embodiment. In the embodiment, the image processor 300 is performed by the image processing system 100, which is not limited herein. To better understand the image processor 300, the image processor 300 is described cooperatively with the image processing system 100. As shown in FIG. 3, the image processor 300 executes following steps.

S301: The sensing unit 102 detects the movement or environmental change of the image processing system 100 to generate environmental information;

S302: The analyzing unit 103 analyzes whether to generate an enable signal according to the environmental information;

S303: The image capturing unit 104 captures the environment image according to the enable signal;

S304: The processing unit 106 performs an image processing on the environment image to generate an object image; and

S305: The display unit 108 displays the object image.

In an embodiment, in step S301, the sensing unit 102 is a photo-sensor, a sound sensor, an image sensor or any other sensors used for detecting a moving object. The sensing unit 102 detects the environmental changes to generate environmental information. In an embodiment, the sensing unit 102 is an accelerometer, a gyroscope, a magnetic sensor or any other sensors used tier detecting the movement of the image processing system 100 to generate the environmental information.

In an embodiment, in step S302, after the image capturing unit 104 captures the environment image according to the enable signal, the environment image is stored in the memory unit 110. In an embodiment, the image capturing unit 104 sends and stores the captured environment image into the memory unit 110. In an embodiment, after the environment image is stored in the memory unit 110, the processing unit 106 obtains the environment image from the memory unit 110 and performs the image processing on the environment image to generate the object image. Then, the processing unit 106 sends and stores the object image in the memory unit 110. Then, the object image can be sent to the display unit 108 from the memory unit 110.

In an embodiment, when the object image is sent from the memory unit 110 to the display unit 108, the image feature processing unit 112 performs an image feature processing on the object image according to the display unit 108. Then, the processed object image is sent to the display unit 108. Thus, the display unit 108 can instantly display the processed object image. In an embodiment, the image feature processing unit 112 adjusts the image feature (such as, the shape and size) of the object image according to the shape and size of the display unit 108. Details for the function of the image feature processing unit 112 can refer to the above embodiments, which is not described repeatedly herein.

In an embodiment, in step S302, when the analyzing unit 103 determines that a moving object 204 appears in the environment surrounding the image processing system 100 according to the environmental information and generates the enable signal, the image capturing unit 104 captures the environment image of the object 204 according to the enable signal. In an embodiment, when the object 204 moves in the environment surrounding the image processing system 100, the sensing unit 102 detects the movement of the object 204 to generate the environmental information. After the analyzing unit 103 determines that the moving object 204 appears in the environment surrounding the image processing system 100 according to the environmental information, the analyzing unit 103 requests the image capturing unit 104 to capture the environment image of the object 204 instantly through the enable signal.

In an embodiment, the image processor 300 is applied in an automation device (such as, a home robot, a health-care robot, a security robot and the like) to support the interaction interface between the user and the automation device, which is not limited herein. In an embodiment, when the user gets close to the automation device which applies the image processor 300, the automation device detects the approach of the user and captures the image of the user immediately. Then the automation device has the image processing on the captured image to generate the image of the user. The image of the user with a mirror reflection effect is displayed instantly. In such a way, the user can determine the interaction relationship with the automation device is already established, which makes the automation device user-friendly.

In an embodiment, in step S302, when the analyzing unit 103 determines the image processing system is moved according to the environmental information, the image capturing unit captures the environment image surrounding the image processing system 100 according to the enable signal. For example, when the position or the orientation of the image processing system 100 changes under the control or an external force, the sensing unit 102 detects the movement of the image processing system 100 and generates the environmental information. After the analyzing unit 103 determines the movement of the image processing system 100 according to the environmental information, the analyzing unit 103 requests the image capturing unit 104 to capture the environment image of the environment surrounding the image processing system 100 through the enable signal.

Please refer to FIGS. 2D and 2E, when the position or the orientation of the image processing system 100 changes under the control or the external force, the sensing unit 102 detects the object surrounding the image processing system 100 is changed from the object 212 to the object 214. Then, the sensing unit 102 generates the environmental information. After the analyzing unit 103 determines the image processing system 100 is moved according to the environmental information, the analyzing unit 103 requests the image capturing unit 104 to capture the environment image of the object 214 through the enable signal.

In the image processing system and the image processor in the embodiments, the image capturing unit determines whether the ambient environment changes according to the environmental information generated by the sensing unit, to selectively capture the environment image. Then, the processing unit performs the image processing on the environment image to generate the object image. The object image is displayed on the display unit instantly. In an embodiment, the object image is an image of the user. The image processing system and the image processor of the present disclosure provides a mirror reflection effect by displaying the object image on the display unit instantly. Therefore, the establishment of the interaction relationship between the automation device and the user can be determined at once, which makes the automation device more user-friendly. Moreover, since the image capturing unit captures the environment image when the environmental change is determined according to the environmental information, which reduces the power consumption of the image capturing unit.

Although the disclosure has been disclosed with reference to certain embodiments thereof, the disclosure is not for limiting the scope. Persons having ordinary skill in the art may make various modifications and changes without departing from the scope of the disclosure. Therefore, the scope of the appended claims should not be limited to the description of the embodiments described above.

What is claimed is:

1. An image processing system, comprising:
a sensing unit, configured for detecting environmental change and generating environmental information;
an analyzing unit, electrically connected to the sensing unit and configured for analyzing whether to generate an enable signal according to the environmental information;
an image capturing unit, electrically connected to the analyzing unit and configured for capturing an environment image according to the enable signal;
a processing unit, electrically connected to the image capturing unit and configured for performing an image processing to the environment image to generate an object image; and
a display unit, electrically connected to the processing unit and configured for displaying the object image.

2. The image processing system according to claim herein the image processing system further comprises:
a memory unit electrically connected to the image capturing unit and the processing unit, and configured for storing the environment image, the processing unit obtains the environment image from the memory unit, performs the image processing on the environment image to generate the object image and stores the object image into the memory unit, and the object image is sent from the memory unit to the display unit.

3. The image processing system according to claim 2, wherein the image processing system further comprises:
an image feature processing unit electrically connected to the memory unit and the display unit, and configured for performing an image feature processing to the object image according to the display unit and sending the processed object image to the display unit.

4. The image processing system according to claim 1, wherein the analyzing unit analyzes whether the environment changes according to the environmental information, when the analyzing unit determines a moving object appears in the environment surrounding the image processing system according to the environmental information, the analyzing unit generates the enable signal, and the image capturing unit captures the environment image of the moving object according to the enable signal.

5. The image processing system according to claim 1, wherein the analyzing unit analyzes whether the environment changes according to the environmental information, when the analyzing unit determines the image processing system is moved according to the environmental information, the analyzing unit generates the enable signal, and the image capturing unit captures the environment image around the image processing system according to the enable signal.

6. An image processor, adapted to an image processing system including a sensing unit, an analyzing unit, an image capturing unit, a processing unit and a display unit, the image processor executes steps comprising:
detecting environmental changes and generating environmental information via the sensing unit;
analyzing whether to generate an enable signal according to the environmental information via the analyzing unit;
capturing an environment image according to the enable signal via the image capturing unit;
performing an image processing to the environment image via the processing unit to generate an object image; and
displaying the object image via the display unit.

7. The image processor according to claim 6, wherein after the image capturing unit captures the environment image according to the enable signal, the environment image is stored in a memory unit, and the step of performing the image processing to the environment image via the processing unit to generate the object image comprises:
obtaining the environment image from the memory unit and performing the image processing to the environment image to generate and store the object image into the memory unit by the processing unit, and sending the object image from the memory unit to the display unit.

8. The image processor according to claim 7, wherein the step of sending the object image from the memory unit to the display unit comprises:
performing the image feature processing to the object image by the image feature processing unit according to the display unit, and sending the processed object image to the display unit.

9. The image processor according to claim 6, wherein the step of analyzing whether to generate the enable signal according to the environmental information via the analyzing unit comprises: analyzing whether the environment changes according to the environmental information via the analyzing unit, if so, generating the enable signal; and
wherein the step of capturing the environment image via the image capturing unit according to the enable signal comprises: capturing the environment image of an moving object via the image capturing unit according to the enable signal when the analyzing unit determines the moving object appears in the environment surrounding the image processing system according to the environmental information, and generating the enable signal.

10. The image processor according to claim 6, wherein the step of analyzing whether to generate the enable signal according to the environmental information via the analyzing unit comprises: analyzing whether the environment changes according to the environmental information via the analyzing unit, if so, generating the enable signal; and
wherein the step of capturing the environment image via the image capturing unit according to the enable signal comprises: capturing the environment image around the image processing system via the image capturing unit according to the enable signal when the analyzing unit determines the image processing system is moved according to the environmental information, and generating the enable signal.
